(19) United States
(12) Patent Application Publication
(10) Pub. No.: US 2012/0215865 A1
(43) Pub. Date: Aug. 23, 2012

(54) METHOD AND SYSTEM FOR INTERCONNECTING SOCIAL NETWORKS

(75) Inventors: David Oliver SACKS, San Francisco, CA (US); Adam Marc PISONI, San Francisco, CA (US); Kris Branson GALE, San Francisco, CA (US); James Robert PATTERSON, San Francisco, CA (US)

(73) Assignee: YAMMER, INC., San Francisco, CA (US)

(21) Appl. No.: 13/402,581

(22) Filed: Feb. 22, 2012

Related U.S. Application Data
(60) Provisional application No. 61/445,520, filed on Feb. 22, 2011.

(51) Int. Cl. G06F 15/16

(52) U.S. Cl. 709/206; 709/204

(57) ABSTRACT

An online community bridges two or more different client social networks and includes users of the client social networks and, optionally, one or more users who are not included in the client social networks. The online community provides an area for micro-blogging to be shared between its users while enforcing a separation between it and the client social networks and maintaining the original separation between the client social networks.

### CROSS-REFERENCE TO RELATED APPLICATIONS

This application claims priority benefit to U.S. provisional patent application titled, “METHOD AND SYSTEM FOR INTERCONNECTING SOCIAL NETWORKS,” filed on Feb. 22, 2011, having application Ser. No. 61/445,520 (Attorney Docket Number YAMR/0003USL), and is incorporated by reference herein.

### BACKGROUND

Micro-blogging has become an effective means of collaborative discussion by allowing participants to share information at any given moment on a topic. In the Yammer® micro-blogging service, each participant is included in a client social network that is associated with the Internet domain name of their email address. For example, if Joe (joe@foo.com) and Bob (bob@foo.com) register with Yammer®, both are automatically included in a client social network associated with foo.com. Further, if Mike (mike@loo.com) and Greg (greg@loo.com) register with Yammer®, both are automatically included in a client social network associated with loo.com.

It should be noted that the foo.com client social network and the loo.com client social network are separated from one another. In this way, users have complete visibility to the micro-blogging within their respective client social networks, but have no visibility to the micro-blogging within any other client social networks. This configuration has several advantages, a key advantage being that information contained within each client social network remains specific to the purpose of the client social network. For example, if foo.com is a software development company, then it is likely that a majority of the discussions contained within the foo.com client social network are specifically directed to practices of software development and matters internal to that company.

Though the aforementioned separation of client social networks has many advantages, the inherent isolation of each client social network limits its usefulness as a social networking tool. For example, knowledge and experience gained by interaction of users of one client social network are contained within that one network.

### SUMMARY

One or more embodiments of the present invention provide an online community that exists between two or more separate client social networks. The online community bridges the two or more client social networks and includes users of the two or more client social networks and, optionally, one or more users who are not included in the two more client social networks. The online community provides an area for micro-blogging to be shared between the users while maintaining the original separation between the two or more client social networks.

A method of managing social connections between different online social networks each having a plurality users, according to an embodiment of the present invention, includes the steps of creating an online community that includes a first online social network, inviting a second online social network to participate in the online community, receiving an indication of participation by the second online social network, and managing interactions between users of the first online social network and users of the second online social network through the online community.

A computer system for managing one or more online communities of different online social networks, according to an embodiment of the present invention, includes a storage unit having stored therein unique IDs of the online communities, a first data set that identifies members of the online communities, and a second data set that identifies members of each of online social networks. The computer system further includes a processing unit that is programmed to permit a user to access an online community if the user is a member of an online social network that is a member of the online community, and to deny the user access to the online community if the user is not a member of the online community or an online social network that is a member of the online community.

A method of executing a process for a target entity based on the target entity's connection to other entities through online communities, according to an embodiment of the present invention, includes the steps of identifying first online social networks that are participating in one or more of the same online communities as the target entity, identifying second online social networks that are participating in one or more of the same online communities as any one of the first online social networks and are not participating in any of the same online communities as the target entity, and executing a process relative to at least one of the entities that own or control the first online social networks and entities that own or control the second online social networks.

Further embodiments of the present invention include, without limitation, a non-transitory computer-readable storage medium that includes instructions that enable a processing unit to implement one or more aspects of the above methods.

### BRIEF DESCRIPTION

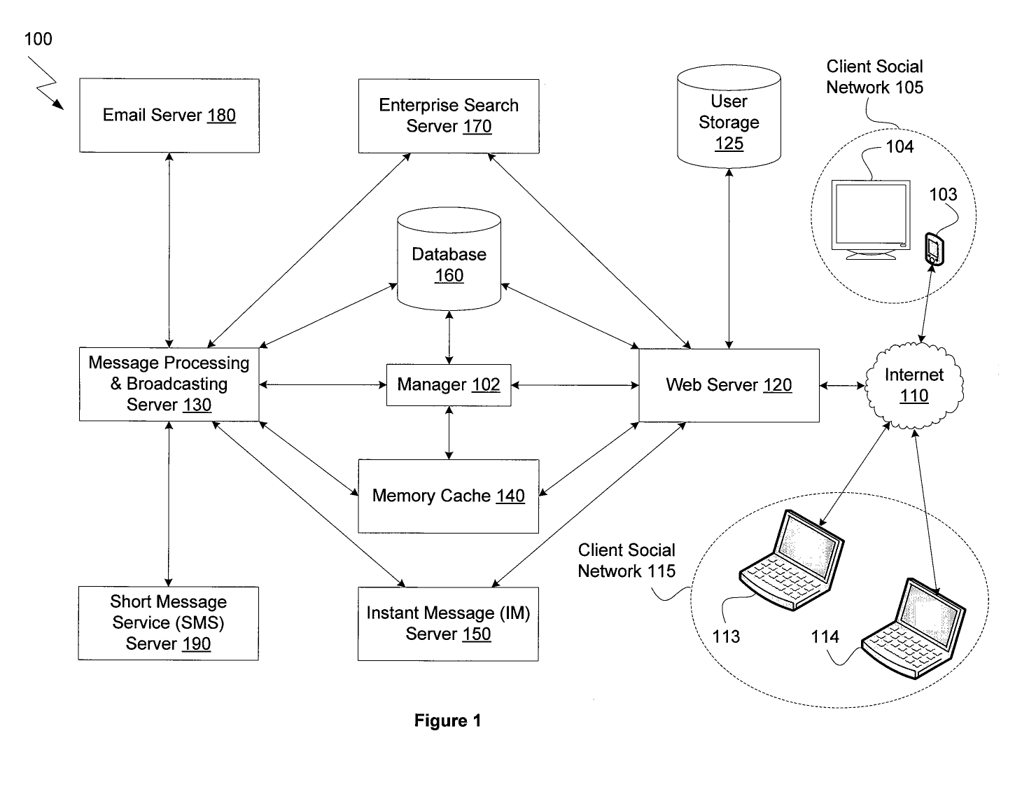

FIG. 1 illustrates an exemplary system for collaborative short messaging and discussion according to one embodiment of the present invention.

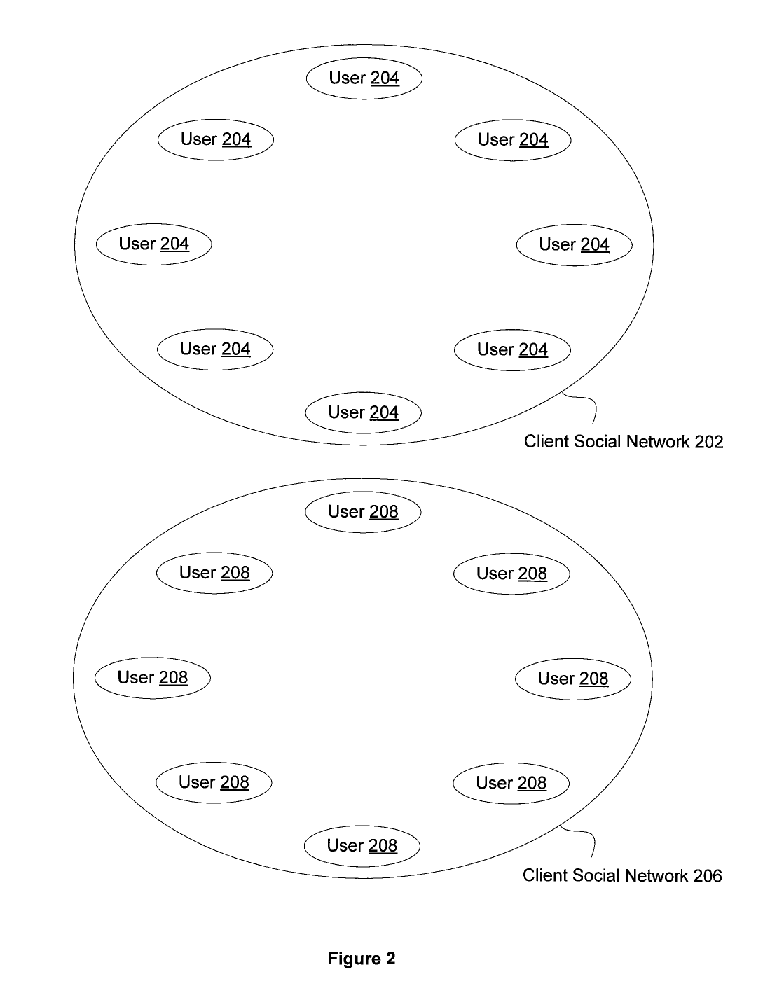

FIG. 2 is a block diagram illustrating client social network configurations according to one or more embodiments of the present invention.

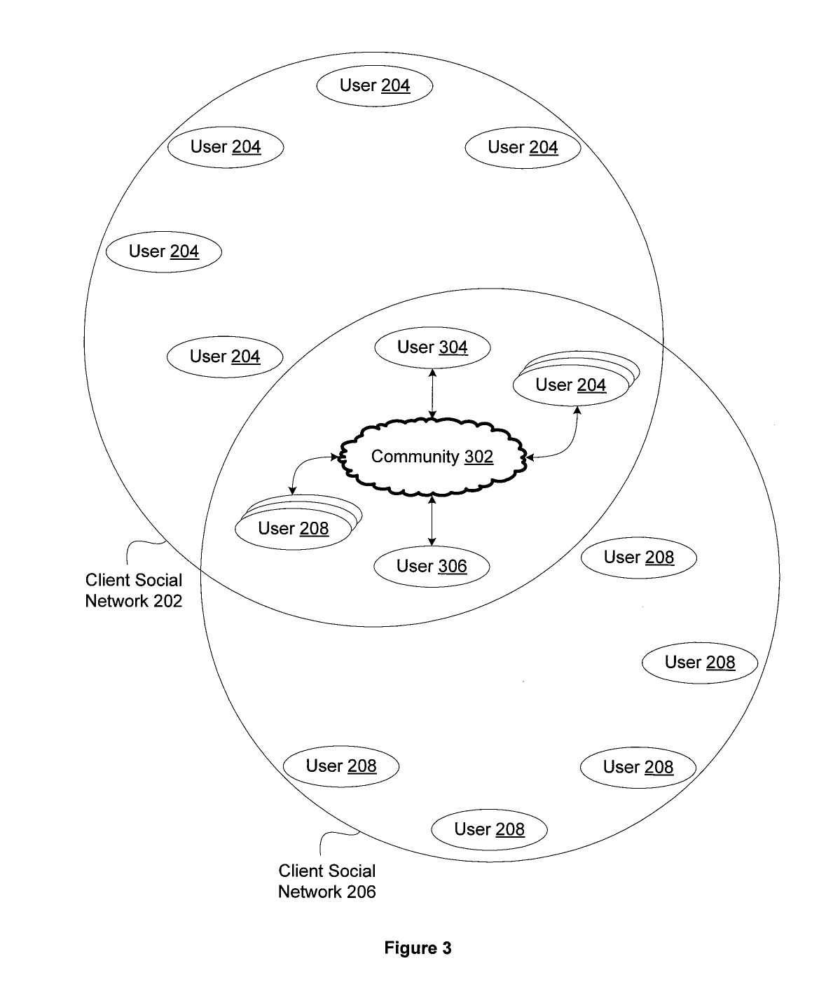

FIG. 3 is a block diagram illustrating a community that exists between two or more client social networks according to one or more embodiments of the present invention.

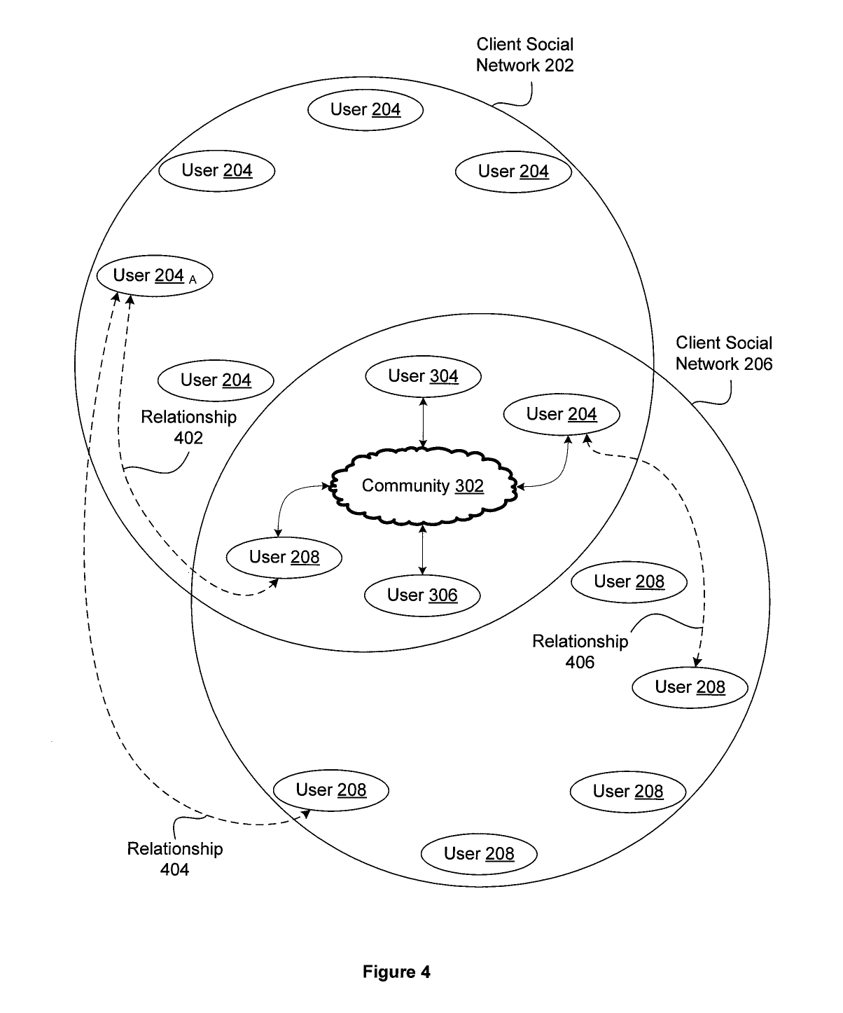

FIG. 4 is a block diagram illustrating intra-community relationships that exist between users who belong to different client social networks, according to one or more embodiments of the present invention.

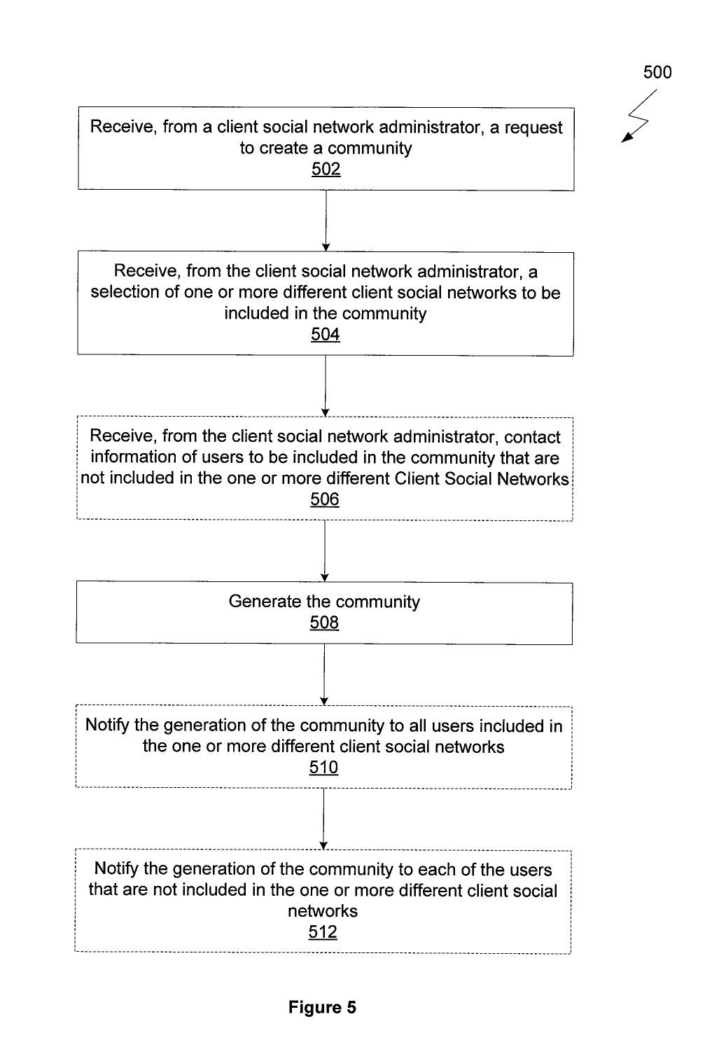

FIG. 5 is a flow diagram of a method of generating a new community according to one or more embodiments of the invention.

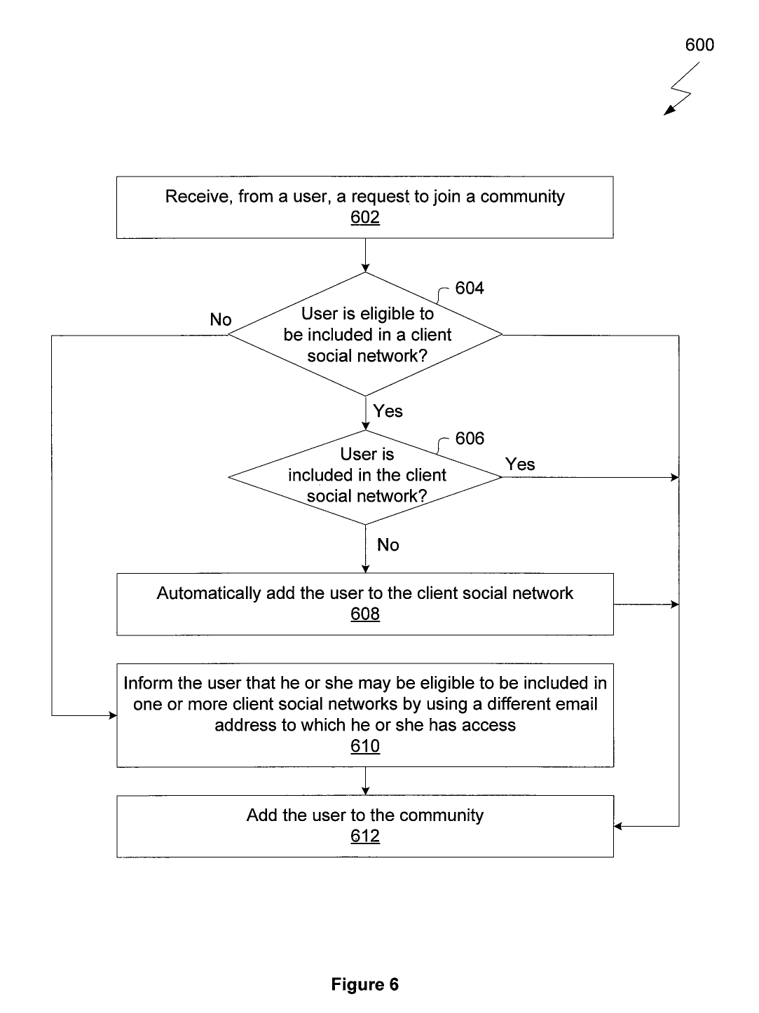

FIG. 6 is a flow diagram of a method of adding a user to a community, according to or more embodiments of the invention.

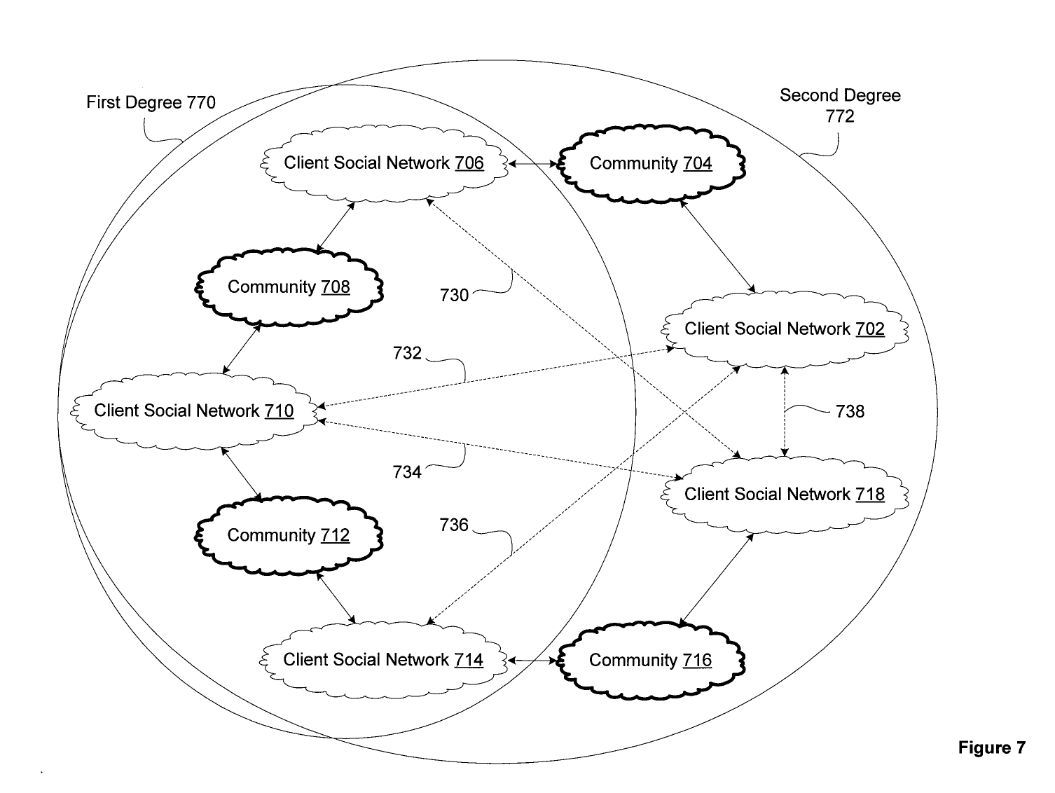

FIG. 7 is a block diagram illustrating implicit client social network relationships via two or more communities, according to one or more embodiments of the present invention.

### DETAILED DESCRIPTION

FIG. 1 illustrates an exemplary system for a micro-blogging system 100, according to one embodiment of the present invention. As shown, micro-blogging system 100 includes a manager 102, client devices 103, 104, 113, and 114, client social networks 105 and 115 with which client devices are associated, internet 110, web server 120, user storage 125, message processing and broadcasting server 130, memory cache 140, instant message (IM) server 150, database 160, enterprise search server 170, email server 180 and short message service (SMS) server 190.

Micro-blogging system 100 is managed by manager 102 and is interconnected by the internet 110 and plurality of networks. According to one embodiment, the networks are described as being the internet; alternatively, the networks may be Wide Area Networks (WAN), a Local Area Networks (LAN), or any other system of interconnection enabling two or more devices to exchange information.

One or more client devices 103, 104, 113, and 114 allow web access via browsers such as Microsoft Internet explorer, Apple Safari, Mozilla Firefox or any other browser that supports HTML and JavaScript. Client devices 103, 104, 113, and 114 may personal computers. Client device 103 is a web enabled phone or other web enabled mobile device. Alternatively, client device 103 is a non-web-enabled mobile phone capable of SMS.

Users of client devices 103, 104, 113, and 114, are included in client social networks that are mediated by manager 102. A user in micro-blogging system 100 is a specific person's account associated with a single client social network. A client social network is a collection of users, messages, and keyword tags. In a client social network a user only has the ability to see public information of other users in that client social network; users outside the client social network cannot see any information in a client social network unless they are specifically granted access to such a client social network. In one embodiment, each user is included in a client social network that is associated with the Internet domain name of the user's email address. For example, in FIG. 1, users of client devices 103 and 104 are included in client social network 105 because their email addresses share the same Internet domain name (e.g., joe@foo.com and bob@foo.com). Likewise, users of client devices 113, and 114 are included in client social network 115 because their email addresses share the same, but a different Internet domain name than foo.com (e.g., chris@loo.com and greg@loo.com).

Web server 120 is a web server that uses any of protocols and/or applications including Hypertext Transfer Protocol (HTTP), File Transfer Protocol (FTP), Extensible Messaging and Presence Protocol (XMPP), or other protocols. The operating system may be Windows, LINUX, SUN Solaris, Mac OS, or other operating system. Users create an account on web server 120 and are included in client social networks. Messages are sent from client devices 103, 104, 113 and/or 114 to web server 120 through internet 110. Messages are received at client devices 103, 104, 113 and/or 114 via web server 120, email server 180, and/or SMS server 190.

Message processing and broadcasting server 130 is a server capable of processing the content of messages, operating a message queue, and directing messages to the appropriate resource in micro-blogging system 100. The operating system may be Windows, LINUX, SUN Solaris, Mac OS, or other operating system. Message processing and broadcasting server 130 may distribute messages to email server 180, SMS server 190, IM server 150, memory cache 140, database 160, and enterprise search server 170.

Instant message server 150 is a server using any protocols and/or applications for sending instant messages including, but not limited to, Extensible Messaging and Presence Protocol (XMPP), ejabberd, and Bi-Directional-Streams Over HTTP (BOSH). Enterprise search server 170 is a server using any protocol and/or application for enterprise searches such as Apache's Solr. User Storage 125 is a storage drive or other device capable of file storage.

FIG. 2 is a block diagram illustrating two separate and distinct client social networks, according to one or more embodiments of the present invention. As shown, a client social network 202 includes a plurality of users 204, while a client social network 206 includes a plurality of users 208. In one example, client social network 202 is associated with an Internet domain name of first fictitious company, e.g., foo.com, while client social network 206 is associated with an Internet domain name of a second fictitious company, e.g., loo.com. With this configuration, users 204 have complete visibility to the micro-blogging within client social network 202, but have no visibility to the micro-blogging within client social network 206. Similarly, users 208 have full visibility to the micro-blogging within client social network 206, but have no visibility to the micro-blogging within client social network 202.

FIG. 3 is a block diagram illustrating a community that exists between two or more client social networks, according to one or more embodiments of the present invention. As shown, client social network 202 and client social network 206 are bridged by a community 302 that includes users 204 and users 208. As also shown, community 302 also includes users 304 and 306—neither of whom belongs to a specific client social network. This may occur, for example, when users 304 and 306 are associated with an Internet domain name whose members are not specific to a particular company (e.g., the Internet domain name of an e-mail hosting service, such as “hotmail.com”). Community 302 provides an area for micro-blogging to be shared between users 204, users 208, user 304 and user 306. Though the original separation between client social network 202 and client social network 206—along with user 304 and user 306—remains intact, inter-client social network micro-blogging is manageable using a number of techniques, as described in further detail below.

Assume, for example, that a user 204 is included in both client social network 202 and community 302. When the user 204 logs in to micro-blogging system 100, he or she is presented with two separate micro-blogs—a first micro-blog associated with client social network 202, and a second micro-blog associated with community 302. Similarly, assume that a user 208 is included in both client social network 206 and community 302. When the user 208 logs into micro-blogging system 100, he or she is presented with two separate micro-blogs—a first micro-blog associated with client social network 206, and a second micro-blog associated with community 302. However, when user 304 or user 306 logs in to micro-blogging system 100, they are presented only with the micro-blog associated with community 302. In this way, each of users 204, 208, 304 and 306 are able to manage their micro-blogging activity within their respective client social networks and/or community. In addition, administrators of client networks may prohibit users included therein to join communities.

FIG. 4 is a block diagram illustrating intra-community relationships that exist between users who belong to different client social networks, according to one or more embodiments of the present invention. As shown, the illustration in FIG. 4 extends the illustration and description of FIG. 3 by identifying intra-community relationships 402, 404 and 406. Note that these intra-community relationships are merely exemplary and that users of micro-blogging system 100 may have any number of intra-community relationships. An intra-community relationship may be formed both explicitly and/or implicitly. An explicit intra-community relationship may be formed, for example, between a user 204 and a user 208 when user 204 selects user 208 and marks him or her as a “favorite.” In contrast, implicit intra-community relationships may be formed, for example, by identifying two or more users that have communicated with one another (via community 302) beyond a particular threshold number of discussions.

The establishment of intra-community relationships provides the non-obvious advantage of highlighting information that is potentially valuable to, e.g., foo.com associated with client social network 202. For example, if foo.com is interested in presenting a new product to loo.com—which is associated with client social network 206—then it is valuable to identify that user 204_{A}, included in client social network 202, is most strongly-tied to the users included in client social network 206. This may be accomplished, for example, by querying database 160 to return a sorted list of users 204 who are explicitly or implicitly associated with users included in client social network 206.

FIG. 5 is a flow diagram of a method 500 of generating a new community according to one or more embodiments of the invention. As shown, method 500 begins at step 502, where manager 102 receives, from a client social network administrator, a request to create a community. Here, the client social network administrator is any user who possesses administrative rights to a particular client social network, e.g., client social network 202. To generate the request, the client social network administrator may, for example, login to micro-blogging system 100, via a webpage hosted by web server 120, whereupon he or she is able to select a “create new community” hyperlink that initializes a process to collect information associated with the new community, as described in further detail below.

At step 504, manager 102 receives, from the client social network administrator, a selection of one or more different client social networks to be included in the community, where the client social network in which the client social network administrator is included is added, by default, to the community. For example, to configure community 302 as described above in conjunction with FIG. 3, the client social network administrator would specify loo.com associated with client social network 206. Upon receipt of the selection of the one or more different client social networks to be added to the community, manager 102 creates a record for the community by, e.g., inserting a new row into database 160 and updating permissions of users included in user storage 125 who are members of the one or more different client social networks to enable them to view information associated with the community. At step 506, manager 102 optionally receives, from the client social network administrator, contact information of users to be included in the community that that the client social network administrator believes are not included in the selected one or more different client social networks—e.g., user 304 and user 306 of FIG. 3. If manager 102 receives this information at step 506, then manager 102 parses the contact information of the users to determine whether the users belong to a client social network included in micro-blogging system 100 and, if necessary, notifies the client social network administrator of the discrepancy. Such a notification may include suggesting that the client social network administrator also adds, in addition to client social network 206, the client social network(s) with which user 304 and/or user 306 are associated, if any.

At step 508, manager 102 generates the community 508, which involves, for example, adding new entries into database 160 and/or user storage 125. At step 510, manager 102 optionally notifies the generation of the community to all users included in the selected one or more different client social networks specified by the client social network administrator and received at step 504. This may include, for example, parsing database 160 to determine the contact method preferences of each of the users included in the selected one or more different client social networks and forwarding a message that enables the user to join the new community, e.g., a hyperlink to a signup page for the new community. At step 512, manager 102 optionally notifies the generation of the community to each of the users that are not included in the selected one or more different client social networks, if provided by the client social network administrator at step 506. These notifications may be sent, e.g., via a SMS service, an email message, a push notification, and the like.

Thus, upon the completion of method steps 500, each of the users is now able to register with and be included in the new community, as described in further detail below in conjunction with FIG. 6.

FIG. 6 is a flow diagram of a method 600 of adding a user to a community, according to or more embodiments of the invention. As shown, the method 600 begins at step 602, where manager 102 receives, from a user, a request to join a community. Referring back to the example described above in step 510 of method 500, the request to join the community may be initialized when the user selects the hyperlink that links to a signup page for the community. In this way, pre-existing users of micro-blogging system 100 may conveniently sign up for the community by providing their credentials to micro-blogging system 100; or, new users of micro-blogging system 100 may sign up by creating an account with micro-blogging system 100, whereupon he or she is added to the new community.

At step 604, manager 102 determines whether the user is eligible to be included in a client social network. Specifically, manager 102 identifies an Internet domain name of the user's email address and then parses a list stored, e.g., in database 160, of generic Internet domain names with which client social networks are ineligible to be associated, e.g., gmail.com or msn.com. If, at step 604, manager 102 determines that the user is eligible to be included in a client social network, then the method 600 proceeds to step 606.

At step 606, manager 102 determines whether the user is already included in the client social network. Specifically, manager 102 queries database 160 to determine whether the user is already included in the client social network. If, at step 606, manager 102 determines that the user is included in the client social network, then the method 600 proceeds to step 612, where manager 102 adds the user to the community. However, if manager 102 determines that the user is not included in the client social network, then the method 600 proceeds to step 608, where manager 102 automatically includes the user in the client social network. This automatic inclusion provides the non-obvious advantage of conveniently associating the user with the client social network to which he or she appropriately belongs, which also increases the overall size of the client social network.

Referring now back to step 604, if manager 102 determines that the user is ineligible to be included in a client social network, then the method 600 proceeds to step 610, where manager 102 informs the user that he or she may be eligible to be included in one or more client social networks by using a different email address to which he or she has access. More specifically, though the user was notified via, e.g., his or her gmail.com email address, it is likely that he or she also possesses an email address with an Internet domain name associated with a company for which he or she works, e.g., foo.com, which, as described in conjunction with various examples herein, is associated with a client social network included in micro-blogging system 100. As a convenience to the user, manager 102 may provide, e.g., a webpage interface that enables the user to search for a client social network associated with his or her company's Internet domain name, such that the user may appropriately become a member. Finally, at step 612, manager 102 adds the user to the community.

Advantageously, the method 600 encourages users to, if appropriate, join micro-blogging system 100 and/or a client social network, in addition to joining the community. This, in turn, increases the overall number of users within client social networks included in micro-blogging system 100 without compromising the micro-blogging focus of client social networks and/or communities included therein.

FIG. 7 is a block diagram illustrating implicit client social network relationships via two or more communities, according to one or more embodiments of the present invention. As shown, implicit client social network relationships 730, 732, 734, 736 and 738 exist between various client social networks. Such information may be advantageously used, for example, to identify potentially important relationships between the companies associated with the client social networks. In one example, client social network 702 is associated with a computer manufacturing company, client social network 706 is associated with a computer sales company, client social network 710 is associated with a computer installation company, client social network 714 is associated with a computer repair company, and client social network 718 is associated with a computer accessories company. As shown, each of the client social networks 702, 706, 710 and 714 and 718 are associated with one or more of communities 704, 708, 712 and 716, where micro-blogging between members of the client social networks and the communities is organized according to the various techniques described herein.

To identify relationships 730, 732, 734, 736 and 738, manager 102 may, for example, parse database 160 and traverse the relationships between the client social networks and the communities to generate the lines illustrated as relationships 730, 732, 734, 736 and 738. In other words, each line that does not represent a relationship between a client social network and a community instead represents an implicit relationship between two client social networks that are not included within a same community. Such relational information may be valuable, for example, by suggesting that the computer repair company (associated with client social network 714) works directly with the computer manufacturing company (associated with client social network 702), which may obviate potential losses in profit endured by the computer repair company when the computer installation company (associated with client social network 710) acts as a middleman between the two. In another example, manager 102 may suggest that the computer manufacturing company (associated with client social network 702) launches an email marketing campaign targeted toward the computer installation company (associated with client social network 710).

Moreover, manager 102 exposes a social graph of the different client social networks connected through one or more communities so that client social networks may execute various business decisions based on this social graph. FIG. 7 illustrates the social graph from the perspective of client social network 710. Client social networks 706 and 714 are related to client social network 710 by one degree of separation because they are part of the same community as client social network 710. Client social networks 702 and 718 are related to client social network 710 by two degrees of separation because they are not part of a same community with client social network 710, but are part of a same community with client social networks 706 and 714, which are one degree-separated from client social network 710. In practice, this social graph may extend to 3, 4, and higher degrees of separation. Using this social graph, client social network 710 may execute a business process, e.g., an e-mail marketing campaign, that favors client social networks that are more closely related. It should also be recognized that closeness of a relationship between two client social networks may be evaluated based on other factors, including the number of online communities in which they co-participate, the number of client social networks in common that are one degree separated from them, and the like.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

What is claimed is:

1. A method of managing social connections between different online social networks each having a plurality users, comprising the steps of:
creating an online community that includes a first online social network;
inviting a second online social network to participate in the online community;
receiving an indication of participation by the second online social network; and
managing interactions between users of the first online social network and users of the second online social network through the online community.

2. The method of claim 1, wherein the interactions between users include messaging within the online community.

3. The method of claim 1, wherein users of first online social network and users of the second online social network are notified of the online community via a short message service (SMS) message, an email, and/or a push notification.

4. The method of claim 1, wherein the interactions between users within the online community are not accessible to the first online social network and the second online social network.

5. The method of claim 1, further comprising:
inviting one or more users that are not included in the first online social network and that are not included in the second online social network; and
receiving an indication of participation by the one or more users.

6. The method of claim 1, wherein the first online social network is associated with a first Internet domain name and most of the users of the first online social network have e-mail addresses containing the first Internet domain name, and the second online social network is associated with a second Internet domain name and most of the users of the second online social network have e-mail addresses containing the second Internet domain name.

7. The method of claim 6, wherein an entity that owns or controls the first Internet domain name and an entity that owns or controls the second Internet domain name are business partners.

8. A computer system for managing one or more online communities of different online social networks, comprising:
a storage unit having stored therein unique IDs of the online communities, a first data set that identifies members of the online communities, and a second data set that identifies members of each of online social networks; and
a processing unit that is programmed to permit a user to access an online community if the user is a member of an online social network that is a member of the online community and deny the user access to the online community if the user is not a member of the online community or an online social network that is a member of the online community.

9. The computer system of claim 8, wherein the processing unit is further programmed to transmit to a user who is a member of an online social network that is a member of the online community, a user interface that includes a control element that permits switching back and forth between the online social network and the online community.

10. The computer system of claim 9, wherein the processing unit is further programmed to transmit user interfaces that display the control element to members of a first online social network and to transmit user interfaces that do not display the control element to members of a second online social network.

11. The computer system of claim 9, wherein the processing unit is further programmed to isolate activities within the online social network of the user from activities within the online community of the online social network of the user.

12. The computer system of claim 9, wherein the processing unit is further programmed to transmit messages and notifications destined for the user that are received through the online community, to the user.

13. The computer system of claim 8, wherein each of the online social networks is associated with a unique e-mail domain name.

14. A method of executing a process for a target entity based on the target entity's connection to other entities through online communities, comprising the steps of
identifying first online social networks that are participating in one or more of the same online communities as the target entity;
identifying second online social networks that are participating in one or more of the same online communities as any one of the first online social networks and are not participating in any of the same online communities as the target entity; and
executing a process relative to at least one of the entities that own or control the first online social networks and entities that own or control the second online social networks.

15. The method of claim 14, wherein the process includes an e-mail marketing campaign.

16. The method of claim 14, wherein the process is executed in favor of the entities that own or control the first online social networks relative to the entities that own or control the second online social networks.

17. The method of claim 16, wherein some of the first online social networks are participating in at least two of the same online communities as the target entity, and the process is executed in favor of entities that own or control the first online social networks that are participating in at least two of the same online communities as the target entity relative to entities that own or control the other first online social networks.

18. The method of claim 14, wherein the process is a request made to an entity that owns or controls one of the first online social networks, for an introduction to an entity that owns or controls one of the second online social networks that participate in the same online community as said one of the first online social networks.

19. The method of claim 14, wherein the process is a recommendation of an entity that owns or controls one of the first online social networks to an entity that owns or controls another one of the first online social networks.

20. The method of claim 14, wherein each of the first and second online social networks is associated with a unique e-mail domain name.
